(19) United States
(12) Patent Application Publication
(10) Pub. No.: US 2015/0175167 A1
(43) Pub. Date: Jun. 25, 2015

(54) COURSE ESTIMATOR

(71) Applicant: DENSO CORPORATION, Kariya-city (JP)

(72) Inventors: Taku SAKIMA, Chiryu-shi (JP); Yuusuke MATSUMOTO, Aichi-ken (JP); Syunya KUMANO, Gothenburg (SE); Naoki KAWASAKI, Kariya-shi (JP)

(21) Appl. No.: 14/576,884

(22) Filed: Dec. 19, 2014

(30) Foreign Application Priority Data
Dec. 25, 2013 (JP) 2013-267659

(51) Int. Cl. B60W 40/072; G01B 21/10

(52) U.S. Cl. CPC B60W 40/072; G01B 21/10

(57) ABSTRACT

This disclosure provides as an aspect a course estimator having a curvature radius estimator, a calculator and a determination section. The curvature radius estimator obtains first information on a forward traveling path ahead of a vehicle in a traveling direction of the vehicle at different time points and estimating, on the basis of the first information obtained repeatedly, each curvature radius of the forward traveling path at a respective time. The calculator calculates change information indicating magnitude of time change in curvature radius of the forward traveling path on the basis of the estimated curvature radiuses of the forward traveling paths. The determination section determines whether or not there is a changing point where a road shape of the forward traveling paths changes on the basis of the calculated change information.

### CROSS-REFERENCE TO RELATED APPLICATION

This application is based on and claims the benefit of priority from earlier Japanese Patent Application No. 2013-267659 filed Dec. 25, 2013, the description of which is incorporated herein by reference.

### BACKGROUND

1. Technical Field

The present invention relates to a course estimator for estimating a state of a course of a vehicle and a non transitory computer-readable storage medium for the same.

2. Related Art

Conventionally, there has been known a device mounted on a vehicle for estimating a road shape (referred to as a course shape) of the forward traveling path to which the own vehicle is going to travel (see PTL1 (JP 2009-9209 A)).

The device disclosed in PTL1 detects the turning direction (and the turning radius) of the own vehicle on the basis of detection results (i.e. yaw rate) of a yaw rate sensor or detection results (i.e. steering angle) of a steering angle sensor. Further, the device estimates the course shape as the detected turning radius and turning direction of the own vehicle under the assumption that the detected turning radius and turning direction are kept on the forward travelling path of the own vehicle.

However, on a road where the curvature changes, the device so disclosed in PTL1 cannot detect the changing point of the curvature, because the device estimates the course shape under the assumption that the detected turning radius and turning direction at specified time are constant on the forward traveling path of the own vehicle. In the device disclosed in PTL1, this causes a deviation of the estimated course shape from the actual course shape of the forward traveling path.

That is, the method of estimating the course shape by the device disclosed in PTL1 has poor accuracy for estimating the course shape.

This disclosure has an object of improving accuracy for estimating a course shape in a course estimator.

### SUMMARY

This disclosure provides as an aspect a course estimator (40) having a curvature radius estimator (40, S110 to S130), a calculator (40, S140) and a determination section (40, S150 to S210). The curvature radius estimator obtains first information on a forward traveling path ahead of a vehicle in a traveling direction of the vehicle at different time points and estimates, on the basis of the first information obtained repeatedly, each curvature radius of the forward traveling path at each respective time. The calculator calculates change information indicating a magnitude of change in curvature radius of the forward traveling path with time on the basis of the estimated curvature radiuses of the forward traveling paths. The determination section determines whether or not there is a changing point where a road shape of the forward traveling paths changes on the basis of the calculated change information.

The magnitude of time change in curvature radius may include, for example, change rate with time, change amount with time, or the like.

It should be noted that the curvature radius is an indicator indicating a radius R of a circular arcuate curved-line of a road. The curvature radius in this disclosure includes not only a direct curvature radius but also an indicator based on a curvature radius such as a curvature (1/R).

The object of this disclosure can be realized not only by the above-described estimator but also by various embodiments such as a program executed in a computer or an estimating method.

### BRIEF DESCRIPTION OF THE DRAWINGS

In the accompanying drawings:

FIG. 1 is a block diagram showing a schematic configuration of a drive assist system having a drive assist ECU as a path estimation device to which the present invention is applied;

FIG. 2 is a flow chart showing a process sequence of a drive assist flow which the drive assist ECU executes;

FIG. 3 is a chart showing the transition of curvature radius, when the own vehicle is going to travel on a type I forward traveling path, (A) showing the curvature radius at time t1, (B) showing the curvature radius at time t2 after the time t1, (C) showing the curvature radius at time t3 after the time t2;

FIG. 4 is a chart showing the transition of the curvature radius in the example shown in FIG. 3;

FIG. 5 is a chart showing the transition of curvature radius, when the own vehicle is going to travel on a type II forward traveling path, (A) showing the curvature radius at time t1, (B) showing the curvature radius at time t2 after the time t1, (C) showing the curvature radius at time t3 after the time t2;

FIG. 6 is a chart showing the transition of the curvature radius in the example shown in FIG. 5; and

FIG. 7 is a chart showing effects of an example of the drive assist process, (A) showing the transition of the curvature radius, (B) showing the transition of absolute value of change information.

### DETAILED DESCRIPTION OF PREFERRED EMBODIMENTS

Hereinafter is described an embodiment with reference to the drawings.

### <Drive Assist System>

A drive assist system 1 is a system mounted to a vehicle (specifically, an automobile). The drive assist system 1 recognizes a road shape of the course (referred to as forward traveling path, below) to which the own vehicle is going to travel, and controls the vehicle velocity or vehicle acceleration to keep a proper distance between the own vehicle and another vehicle (leading vehicle) which is traveling ahead of the own vehicle.

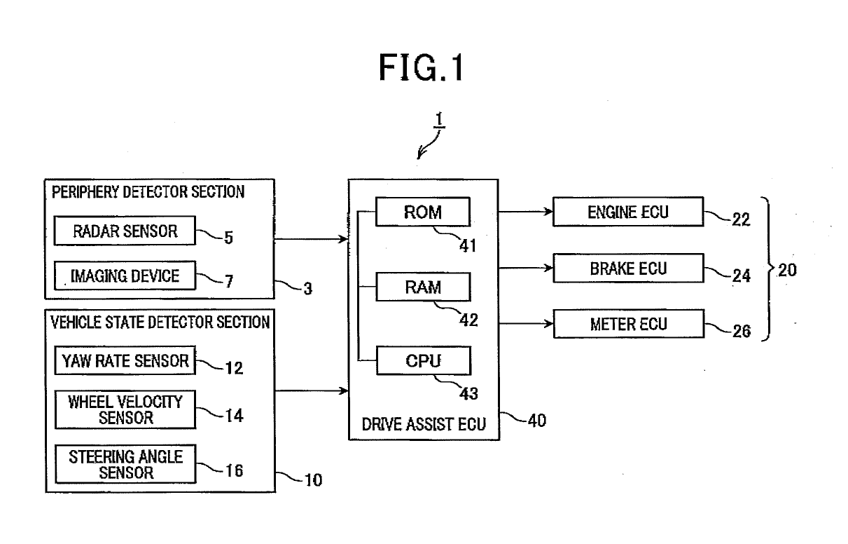

In order to realize this, the drive assist system 1 has a periphery detector section 3, a vehicle state detector section 10, a vehicle control section 20, and a drive assist control unit (referred to as a drive assist ECU in this embodiment) 40, as shown in FIG. 1.

The periphery detector section 3 obtains information (referred to as state estimation information, below) for detecting the state of the forward traveling path. The periphery detector section 3 has a radar sensor 5 and an imaging device 7.

The radar sensor 5 transmits and receives detection waves, and detects, on the basis of the results of transmitting and receiving the detection waves, a position of a target which has reflected the detection waves as the state estimation information. The radar sensor 5 in this embodiment is a laser radar which outputs laser light as the detection waves by scanning a predetermined angular range ahead of the own vehicle. Also, the laser radar detects the reflected light. The radar sensor 5 calculates distance and angle measurement data as the position of the target. The distance measurement data indicates a distance to an object, and is calculated from the time taken for the laser light to reach and return from the object which has reflected the laser light. The angle measurement data indicates the orientation of the object which has reflected the laser light.

It should be noted that the radar sensor 5 is not limited to a sensor using laser light as detection wave. As the radar sensor 5, there may be used a sensor (so-called millimeter-wave radar) using radio waves in a millimeter-wave band as detection waves, or a sensor (so-called sonar) using sonic waves as detection waves.

The imaging device 7 is a well-known camera mounted to a vehicle such as to image a predetermined angular range in the traveling direction of the own vehicle. The imaging device 7 obtains an image which itself has captured as the state estimation information,

The vehicle state detector section 10 obtains information indicating the behavior of the own vehicle. The vehicle state detector section 10 has a yaw rate sensor 12, wheel velocity sensors 14, and a steering angle sensor 16.

The yaw rate sensor 12 outputs a signal depending on the turning angular velocity (yaw rate) y of the own vehicle.

The wheel velocity sensors 14 are provided to each of a left front wheel, a right front wheel, a left rear wheel and a right rear wheel. The wheel velocity sensor 14 outputs pulse signals each having a sharp edge which occurs when a rotating axis of the wheel is at a predetermined rotational angle, i.e. pulse signals at pulse intervals depending on rotational velocity of the axis of the wheel.

The steering angle sensor 16 outputs a signal depending on steering angle, for example, relative steering angle (change amount of steering angle) of a steering wheel or absolute steering angle (actual steering angle based on a steering position when the vehicle is traveling straight) of the steering wheel.

The vehicle control section 20 has electronic control units (ECU) that control vehicle equipment mounted on the vehicle. The vehicle control section 20 has an engine ECU 22, a brake ECU 24, and a meter ECU 26.

The engine ECU 22 is an electronic control unit having a CPU, a ROM, a RAM and so on, and controls start and stop of the engine, fuel injection amount, ignition timing, etc. Specifically, the engine ECU 22 controls an actuator that opens and closes a throttle valve provided at an intake pipe, depending on a detection value of a sensor for detecting depression amount of an accelerator pedal. The engine ECU 22 controls the throttle actuator on the basis of an instruction from the drive assist ECU 40 to increase or decrease driving force of an internal combustion engine.

The brake ECU 24 is an electronic control unit having a CPU, a ROM, a RAM, etc. The brake ECU 24 controls braking of the own vehicle. Specifically, the brake ECU 24 controls a brake actuator to increase or decrease braking force, depending on control input from the driver. In this embodiment, the brake system is a hydraulic brake, and the brake ECU 24 controls an actuator that opens and closes a valve for increasing or decreasing pressure of working fluid, depending on a detection value of a sensor detecting the depression amount of the brake pedal. Further, the brake ECU 24 controls the brake actuator to increase or decrease the braking force, on the basis of instructions from the drive assist ECU 40.

The meter ECU 26 is an electronic control unit having a CPU, a ROM, a RAM, etc. The meter ECU 26 controls display of information on so a meter display provided to the vehicle, on the basis of instructions from each portion of the vehicle including the drive assist ECU 40. Specifically, the meter ECU 26 displays the vehicle velocity, the rotational speed of the engine, an execution state or control mode of control which a controller for inter-vehicle control executes on the meter display.

### <Drive Assist ECU>

The drive assist ECU 40 is an electronic control unit that executes drive assist control. The drive assist ECU 40 has a well-known computer including at least a ROM 41, a RAM 42, a CPU 43 and the like, as a main portion.

The ROM 41 stores programs and data which need to be held even when electric power is not supplied. The RAM 42 temporarily stores processing programs and data. The CPU 43 executes processes on the basis of the processing program stored in the ROM 41 and RAM 42.

Further, the drive assist ECU 40 has a detection circuit, an input-output interface (I/O), and a communication circuit. The detection circuit detects the signals from the periphery detector section 3 and the vehicle state detector section 10 and converts them into digital values. The I/O receives the input from an A/D converter of the detection circuit. The communication circuit communicates with the vehicle control section 20. These circuits have well-known hardware constructions, therefore detail descriptions are omitted.

The ROM 41 contains thereon process programs for a drive assist process executed by the drive assist ECU 40. In the drive assist process, the drive assist ECU 40 recognizes the road shape of the forward traveling path on the basis of the signals from the periphery detector section 3 and the vehicle state detector section 10. The drive assist ECU 40 assists driving of the own vehicle on the basis of the so recognition, thereby performing a drive assist control. The drive assist control described here includes, for example, adaptive cruise control (ACC).

The ACC is a well-known control. In the ACC, the drive assist ECU 40 specifies a target vehicle on the basis of the signals from the periphery detector section 3 and the vehicle state detector section 10, and outputs to the engine ECU 22 or the brake ECU 24 a control command to keep an inter-vehicular distance to the specified target vehicle at a predetermined distance. Further, in the ACC, the drive assist ECU 40 may output to the meter ECU 26 display information related to the ACC or a command for issuing an alarm when a predetermined condition is satisfied.

### <Drive Assist Process>

Next is described the drive assist process executed by the drive assist ECU 40.

The drive assist process is executed repeatedly at a predetermined time intervals (for example, 100 ms).

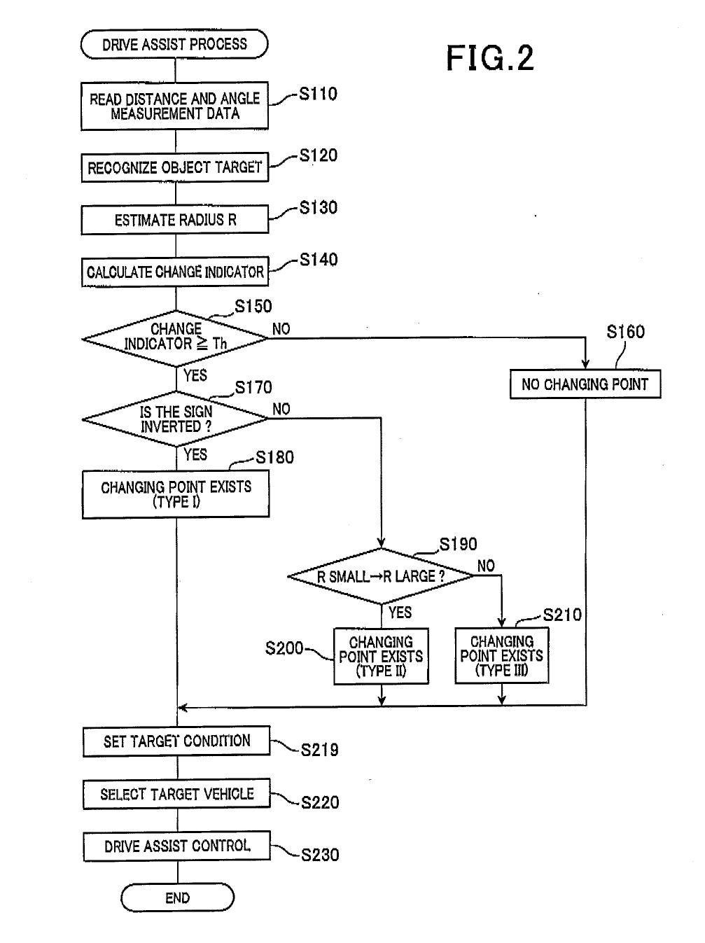

On starting the drive assist process, as shown in FIG. 2, at first, the drive assist ECU 40 reads the state estimation information detected by the periphery detector section 3 (S110). In S110 of this embodiment, as the state estimation information, the drive assist ECU 40 reads the distance and angle measurement data detected by the radar sensor 5.

Subsequently, the drive assist ECU 40 converts the distance and angle measurement data read in the S110 expressed in the polar coordinate system to the Cartesian coordinate system. Thereafter, the drive assist ECU 40 executes, on the basis of the converted data, a target recognition process for recognizing the target existing ahead of the own vehicle (S120). In the target recognition process, the drive assist ECU 40 clusters the distance and angle measurement data and so calculates, for each cluster, a central position coordinate of a target, the size of the target, the relative velocity of the target to the own vehicle, and the like. Further, in the target recognition process, the drive assist ECU 40 detects a respective type (for example, whether the target is a roadside object (a guardrail) or leading vehicle) of each recognized target.

Further, the drive assist ECU 40 estimates the curvature radius R of the forward traveling path on the basis of the state estimation information detected by the periphery detector section 3 or the behavior of the own vehicle detected by the vehicle state detector portion 10. Thereafter, the drive assist ECU 40 stores, on the RAM 42, the estimated curvature radius R and information on the time, i.e. as time-series data of the estimated curvature radius R, when the curvature radius R is estimated (S130).

Specifically, in S130 of this embodiment, by a well-known method, the drive assist ECU 40 estimates the alignment of the forward traveling path on the basis of the position of the roadside object (for example, a guardrail) recognized in the S120, and estimates the curvature radius R. It should be noted that the curvature radius R described here includes the curvature radius and the turning direction. In this embodiment, left turn is expressed by a positive value and right turn is expressed by a negative value.

The estimation method is not limited to the above method. There may be used a method based on the image captured by the imaging device 7 or a method based on the detection results of the vehicle state detector section 10.

For example, in the former method, the drive assist ECU 40 may recognize a lane marker (for example, a white line) by a well-known method based on the image captured by the imaging device 7, and estimate the alignment of the forward traveling path on the basis of the recognized lane marker, thereby estimating the curvature radius R. For example, in the latter method, the drive assist ECU 40 may calculate the curvature radius R, on the basis of the yaw rate γ detected by the yaw rate sensor 12 and the velocity V (referred to as own velocity) of the own vehicle calculated based on the detection result of the wheel velocity sensor 14, by dividing the own velocity V by the yaw rate γ.

Further, the method for estimating the curvature radius R is not limited to the above method, for example, there may be used a combination of these methods. In this case, the average or weighted average of the turning radiuses estimated by various methods may be defined as the curvature radius R.

Subsequently, in S140, the drive assist ECU 40 calculates a change indicator on the basis of the curvature radius R estimated in S130 every time the drive assist process is initiated. The change indicator indicates the magnitude of the change in curvature radius of the forward traveling path with time, and is an example of the change information in this disclosure.

In S140, specifically, the drive assist ECU 40 calculates the difference (i.e. change amount) with time between the curvature radius R estimated in S130 during the previous drive assist process and the curvature radius R estimated in S130 during the current drive assist process. Thereafter, in S140, the drive assist ECU 40 calculates, as the change indicator, an arithmetic average of change amounts calculated for a given number of intervals (for example, ten intervals) within an execution interval.

Alternatively, in S140, the drive assist ECU 40 may calculate, as the indicator, a change rate by dividing the change amount of the curvature radius R with time by an execution interval of the drive assist process.

Thereafter, the drive assist ECU 40 determines whether or not the absolute value of the change indicator calculated in S140 is equal to or more than a predetermined threshold Th (S150). Here, the predetermined threshold Th is an upper limit of the indicator where the curvature radius can be determined as being switched.

Next, if the absolute value of the change indicator is less than the threshold Th (S150: NO) as the determination result in S150, the drive assist ECU 40 determines there is no changing point, and proceeds to S160. In S160, the drive assist ECU 40 sets, as the road shape of the forward traveling path, a road shape having no changing point (for example, straight road), and proceeds to S220.

On the other hand, as the determination result in S150, the absolute value of the change indicator is equal to or larger than the threshold (S150: YES), the drive assist ECU 40 proceeds to S170.

In S170, the drive assist ECU 40 estimates time transition of the turning direction in the forward traveling path. Thereafter, the drive assist ECU 40 determines whether or not the time transition of the turning direction shows the turning direction is inverted. Specifically, in S170 of this embodiment, if the signs of the curvature radius R with time are inverted along time axis, the drive assist ECU 40 determines the signs show the turning direction is inverted.

As the determination result in S170, if the time transition shows the turning direction in the forward traveling path is inverted (S170: YES), the drive assist ECU 40 sets type I as the road shape of the forward traveling path (S180). Here, type I is one type of the road shapes having a changing point on the forward traveling path, for example, a S-shaped curve where the road shape switches from a left-curved road to a right-curved road.

After that, the flow proceeds to S220.

On the other hand, as the determination result in S170, if the time transition does not show the turning direction of the forward traveling path is inverted, the flow proceeds to S190.

In S190, the drive assist ECU 40 determines whether the absolute value of the curvature radius R increases along the time axis. As the determination result in S190, if the absolute value of the curvature radius R increases along the time axis (S190: YES), i.e. if the difference (=|R(t)|−|R(t−1)|) between the absolute values of the curvature radiuses R is positive, the drive assist ECU 40 sets type II as the road shape of the forward traveling path (S200). Here, R(t) means the current curvature radius, and R(t−1) means the previous curvature radius.

Here, the type II is one type of the road shapes having a changing point on the forward traveling path, and the road shape where the curvature becomes small forward. The type II includes, for example, a road shape switching from a curved road to a straight road, and a road shape switching from a sharp-curved road to a gently-curved road.

After that, the flow proceeds to S220.

As the determination result in S190, if the absolute value of the curvature radius R does not increase with time (S190: NO), the drive assist ECU 40 sets type III as the road shape of the forward traveling path (S210). That is, for example, if the absolute value of the curvature radiuses R decreases with time, i.e. if the difference (−|R(t)|−|R(t−1)|) between the absolute values of the curvature radiuses R is negative, in S210, the drive assist ECU 40 sets type III as the road shape of the forward traveling path.

Here, the type III is one type of the road shapes having a changing point on the forward traveling path, and the road shape where the curvature becomes large forward. The type III includes, for so example, a road shape switching from a straight road to a curved road, and a road shape switching from a gently-curved road to a sharp-curved road.

Thereafter, the flow proceeds to S219 and S220. In the S220, the drive assist ECU 40 selects a leading vehicle

(referred to a target vehicle, below) satisfying a given target condition as a leading vehicle of a target vehicle. The target condition is, for example, that a new target vehicle is selected when the leading vehicle satisfied a specified requirement continuously for a specified time period.

Since the specified requirement is well-known, detailed description is omitted here. An example of the specified requirement is that the vehicle is closest to the own vehicle among the leading vehicles existing in the forward traveling path.

In this embodiment, before S220, at first, in S219, the drive assist ECU 40 sets the target condition depending on the determination results of the changing point and road shape (S150 to S210). For example, if there is a changing point, the above specified time period is lengthened. In this case, if there is a changing point, a new target vehicle is less likely to be selected, and the present target vehicle is more likely to be maintained. Alternatively, if there is a changing point, the selecting interval of the target vehicle may be elongated. That is, if there is a changing point, the target condition is changed so that the probability of excluding the selected target vehicle is decreased.

Thereafter, the drive assist ECU executes S220.

Subsequently, the drive assist ECU 40 outputs the engine ECU 22 or the brake ECU 24 the control command for keeping an inter-vehicular distance to the target vehicle selected in the S200 at a predetermined distance (S230). The engine ECU 22 or the brake ECU 24 controls the throttle actuator or the brake actuator on the basis of the control command received from the drive assist ECU 40.

Further, in S230, the drive assist ECU 40 outputs the meter ECU 26 display information on the ACC or the command for issuing an alarm when a predetermined condition is satisfied. In response to reception of the command, the meter ECU 26 displays the display information or alarms such as on a display panel.

After that, the drive assist ECU 40 terminates the drive assist process, and waits until the next iteration.

That is, in the drive assist process of this embodiment, the drive assist ECU 40 acquires the state estimation information detected by the periphery detector unit 3 and the behavior of the own vehicle detected by the vehicle state detector unit 10, every time the drive assist process is initiated. Thereafter, on each acquirement, the drive assist ECU 40 estimates the curvature radius R of the forward traveling path on the basis of the acquired state estimation information and the behavior of the own vehicle, and stores the estimation result and the time information of the estimation in the RAM 42.

Further, in the drive assist process, the drive assist ECU 40 calculates the change information indicating the magnitude of change in curvature radius with time. If the absolute value of the calculated change information is equal to or larger than the threshold, the drive assist ECU 40 determines the forward traveling path has a changing point where the road shape changes.

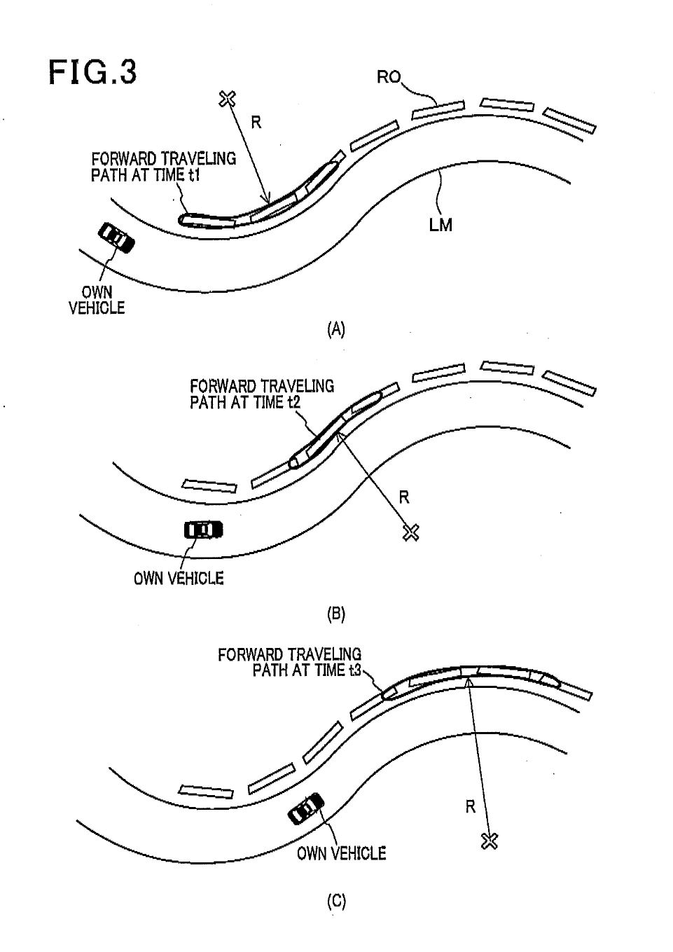

FIG. 3 is a chart showing the transition of the curvature radius R recognized in the drive assist process, when the own vehicle is going to travel on a type I (an S-shaped curve) forward traveling path. (A) of

FIG. 3 shows the curvature radius R calculated by the drive assist ECU 40 at time t1. (B) of FIG. 3 shows the curvature radius R calculated by the drive assist ECU 40 at time t2 after the time t1. (C) of FIG. 3 shows the curvature radius R calculated by the drive assist ECU 40 at time t3 after the time t2.

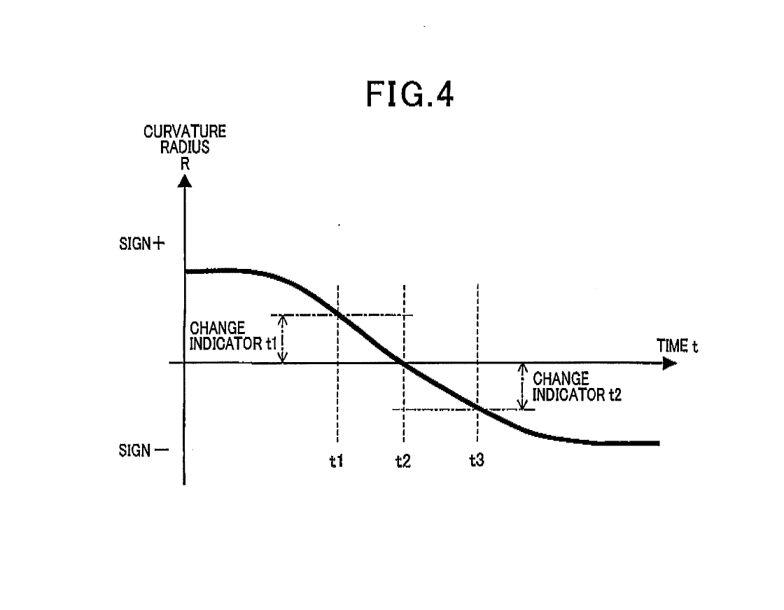

When the own vehicle travels on such as type I forward traveling path, as shown in FIG. 4, the curvature radius R estimated in the drive assist process is a positive at the time t1, and becomes a negative at the time t3, regardless of the calculation methods of the curvature radius R. Between the time t1 and the time t3, the sign of the curvature radius R is inverted. Accordingly, by the drive assist process of this embodiment, the road shape can be estimated as the type I.

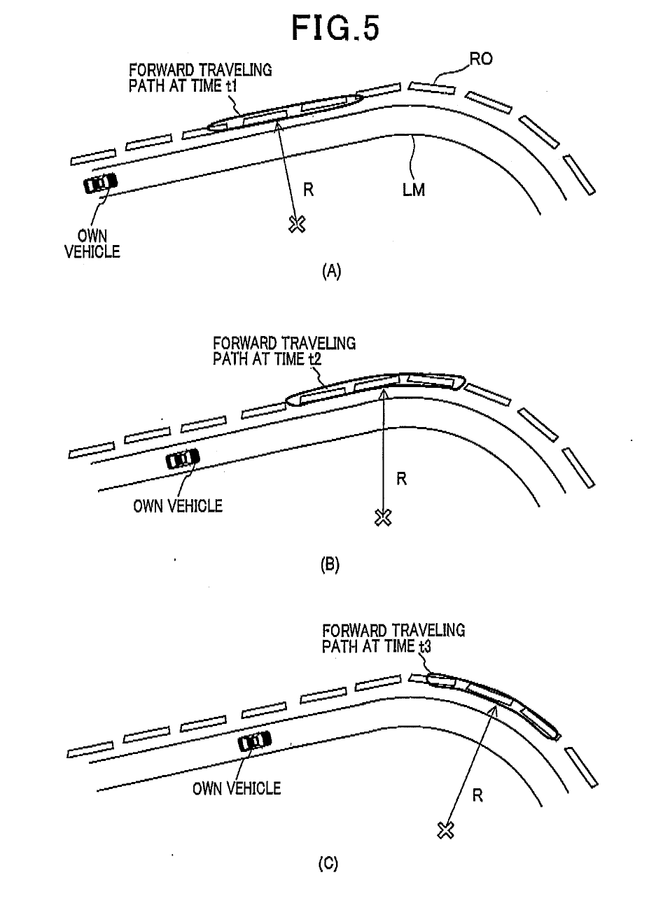

FIG. 5 is a chart showing the transition of the curvature radius R recognized in the drive assist process, when the own vehicle is going to travel on a type II (for example, a road shape switching from a straight road to a right-curved road) forward traveling path. (A) of FIG. 5 shows the curvature radius R calculated by the drive assist ECU 40 at time t1. (B) of FIG. 5 shows the curvature radius R calculated by the drive assist ECU 40 at time t2 after the time t1. (C) of FIG. 5 shows the curvature radius R calculated by the drive assist ECU 40 at time t3 after the time t2.

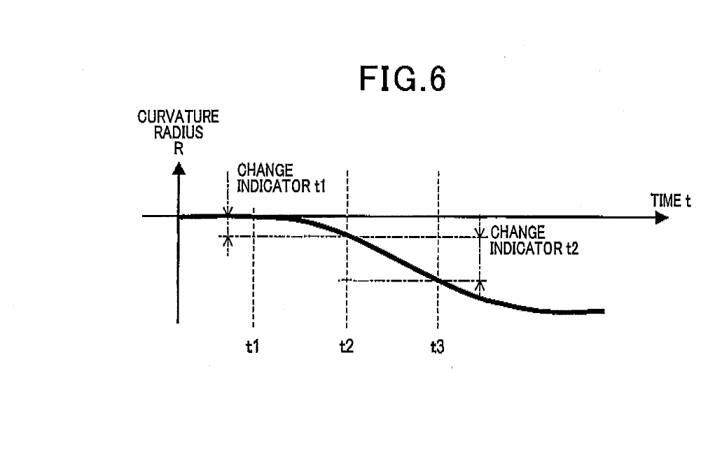

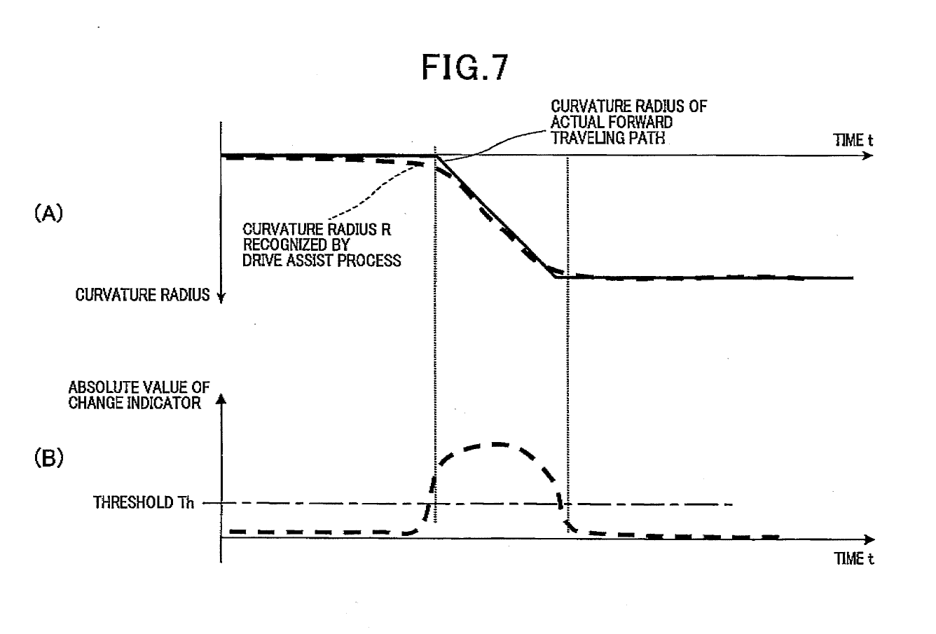

When the own vehicle travels on the type II forward traveling path, as shown in FIG. 6, the curvature radius R estimated in the drive assist process decreases gradually with time, regardless of the calculation methods of the curvature radius R. In this case, as shown in FIG. 7, the absolute value of the change indicator increases by threshold Th or more. Accordingly, by the drive assist process, the road shape of the forward traveling path can be estimated as the type II.

That is, the drive assist ECU 40 executing the drive assist process serves as the course estimator described in the claims.

### Effects of this Embodiment

As described above, the drive assist ECU 40 can determine whether the forward traveling path has a changing point.

Accordingly, the drive assist ECU 40 can decrease possibility of the estimated road shape deviating from the actual road shape of the forward traveling path.

That is, the drive assist ECU 40 can improve estimation accuracy of the forward traveling path.

In the drive assist process of this embodiment, when the time transition of turning direction on the forward traveling path shows the turning direction is inverted, the drive assist ECU 40 estimates the road shape of the forward traveling path as the type I (i.e., S-shaped curve).

As a result, according to the drive assist process, the road shape of the forward traveling path can be estimated as the type L

In the drive assist process of this embodiment, if the absolute value of the curvature radius R increases with time, the drive assist ECU 40 estimates the road shape of the forward traveling path as the type II (i.e. a road shape such as to switch from a straight road to a curved road).

As a result, according to the drive assist process, the road shape of the forward traveling path can be estimated as the type II.

In the drive assist process of this embodiment, if the absolute value of the curvature radius R does not increase with time, i.e. if the absolute value of the curvature radius R decreases with time, the drive assist ECU 40 estimates the road shape of the forward traveling path as the type III (i.e. a road shape such as to switch from a curved road to a straight road).

As a result, according to the drive assist process, the road shape of the forward traveling path can be estimated as the type III.

Further, in the drive assist process, the target condition for selecting the target vehicle is set depending on the determination results of the changing point.

That is, even if there is a changing point in the forward traveling path, in the prior art, the existence of the changing point cannot be recognized. This leads to the risk of incorrectly recognizing the leading vehicle existing on the forward traveling path of the own vehicle as a vehicle which does not exist on the forward traveling path of the own vehicle, thereby the target vehicle is not selected correctly.

On the other hand, the drive assist ECU 40 can recognize existence of a changing point of road shapes. Therefore, determination of a target vehicle using this result can decrease the possibility of excluding the proper target vehicle from the target vehicle.

### Modifications

Though the invention has been described with respect to the specific preferred embodiments, many variations and modifications will become apparent to those skilled in the art upon reading the present application. It is therefore the intention that the claims be interpreted as broadly as possible in view of the prior art to include all such variations and modifications.

For example, the use of the determination results of the changing point is not limited to the process of selecting the target vehicle. For example, if a changing point is detected, a time constant of a filter for processing data may be lowered. Specifically, for example, a time constant of a noise filter (ex. an LPF) for removing noise (ex. high frequency component) from the time-series data detected by the vehicle state detector section 10 or the periphery detector section 3 may be changed depending on the determination results of the changing point, and the data which has passed through the filter may be used for the drive assist process.

More specifically, for example, the drive assist ECU 40 may have a predicting means (using another estimating method different from S150 to S210) for estimating the road shape of the forward traveling in S220, and recognize the leading vehicles on the forward traveling path estimated by the predicting means. The predicting means passes the time-series measurement data of the behavior of the own vehicle through a filter for estimating the road shape of the forward traveling path under the assumption that the behavior of the own vehicle is still kept, thereby estimating the road shape of the forward traveling path.

In this case, if there is a changing point, the time constant of the filter is lowered. This can cause the estimation results of the road shape of the forward traveling path by the predicting means to follow the behavior of the own vehicle, thereby improving responsibility.

The periphery detector section 3 of this embodiment has both the radar sensor 5 and the imaging device 7, but need not to have both in the present invention. The periphery detector section 3 may have only any one of the radar sensor 5 and the imaging device 7.

The vehicle state detector section 10 has the yaw rate sensor 12, the wheel velocity sensor 14 and the steering angle sensor 16, but a vehicle state detector section 10 of the present invention is not limited to this. For example, in the vehicle state detector section 10, the angle sensor 16 may be omitted, or the yaw rate sensor 12 may be omitted. That is, a vehicle state detector section 10 of the present invention may be any detector section which only has to have a sensor detecting the turning angle of the own vehicle and a sensor detecting the vehicle velocity of the own vehicle.

Further, in the present invention, the vehicle state detector section 10 may be omitted.

There may be applied an embodiment where a part of elements of the above embodiment is omitted as long as solves the problems. Also, there may be an arbitrary combination of the above embodiment and any one of the modifications.

What is claimed is:

1. A course estimator, comprising:
a curvature radius estimator obtaining first information on a a forward traveling path ahead of a vehicle in a traveling direction of the vehicle at different time points and estimating, on the basis of the first information obtained repeatedly, each curvature radius of the forward traveling path at each respective time;
a calculator calculating change information indicating a magnitude of change in curvature radius of the forward traveling path with time on the basis of the estimated curvature radiuses of the forward traveling paths; and
a determination section determining whether or not there is a changing point where a road shape of the forward traveling paths changes on the basis of the calculated change information.

2. The course estimator according to claim 1, wherein
the determination section has a first estimator estimating the road shape of the forward traveling paths as an S-shaped curve, if the turning direction in the forward traveling paths is inverted with time.

3. The course estimator according to claim 1, wherein
the determination section has a second estimator estimating the road shape having a curvature decreasing along the forward traveling paths, when the curvature radius indicated by the change information increases with time.

4. The course estimator according to claim 1, wherein
the determination section has a third estimator estimating the road shape having a curvature increasing along the forward traveling paths, when the curvature radius indicated by the change information decreases with time.

5. A non transitory computer-readable storage medium containing thereon a program comprising instructions, the instructions comprising:
obtaining first information on a forward traveling path ahead of a vehicle in a traveling direction of the vehicle at different time points;
estimating, on the basis of the first information obtained repeatedly, each curvature radius of the forward traveling path at a respective time point;
calculating change information indicating magnitude of time change in curvature radius of the forward traveling path on the basis of the estimated curvature radiuses of the forward traveling paths; and
determining whether or not there is a changing point where a road shape of the forward traveling paths changes on the basis of the calculated change information.
